(19) United States
(12) Patent Application Publication
(10) Pub. No.: US 2024/0236446 A1
(43) Pub. Date: Jul. 11, 2024

(54) METHOD FOR EDITING IMAGE, DEVICE, AND COMPUTER PROGRAM CAPABLE OF EXECUTING BACKUP

(71) Applicant: KINEMASTER CORPORATION, Seoul (KR)

(72) Inventor: Jong Deuk KIM, Seongnam-si, Gyeonggi-do (KR)

(21) Appl. No.: 18/556,995

(22) PCT Filed: Apr. 27, 2022
(86) PCT No.: PCT/KR2022/006019

§ 371 Date: Oct. 24, 2023

(30) Foreign Application Priority Data
Apr. 28, 2021 (KR) 10-2021-0054773
Apr. 27, 2022 (KR) 10-2022-0052062

(51) Int. Cl. H04N 21/845; H04N 21/231; H04N 21/234

(52) U.S. Cl. CPC H04N 21/8456; H04N 21/23113; H04N 21/23424

(57) ABSTRACT

Disclosed herein a video editing method, device and computer program capable of performing backup. The method includes: loading original media selected as an editing target by a user into a clip setting area of a video project; creating trim media according to a trim request of the user for the original media loaded into the clip setting area; and storing the trim media as backup media, in response to a request to set storage of the backup media in the video project by the user.

### TECHNICAL FIELD

The present disclosure relates to a video editing method, device, and computer program capable of performing backup, and to a video editing method, device, and computer program capable of performing backup, so that backup media of an edited video may be stored and utilized in subsequent editing.

### BACKGROUND ART

Recently, as portable terminals such as smartphones and tablets have been widely spread, performance of these portable terminals has been improved and wireless communication technology has been developed, users can shoot, edit, and share videos using their portable terminals.

However, in portable terminals, due to limitations in the size of a display screen and performance of hardware, users cannot smoothly edit videos as in a general PC environment. In order to improve this inconvenience, user demand for a video editing method that can be used in a portable terminal is increasing.

Furthermore, as the needs of users of portable terminals increase, the performances of camera devices, display devices, and hardware of portable terminals are being upgraded, and many functions or services used in PC environments are being performed by portable terminals. In particular, since portable terminals are basically provided with a camera device, user needs for editing still images or videos captured through the camera device are increasing.

Meanwhile, video editing may be performed using original media such as photos and videos stored in the mobile terminal. However, the original media may be arbitrarily deleted by the user, and when editing change is made to the already edited video in a situation where the original media has been deleted, the edited video based on the original media cannot be changed due to the absence of the original media.

### DISCLOSURE

### Technical Problem

The technical problem of the present disclosure relates to a video editing method, device, and computer program capable of performing backup, and provides a video editing method, device, and computer program capable of performing backup so that backup media of an edited video may be stored and utilized in subsequent editing.

The technical problems solved by the present disclosure are not limited to the above technical problems and other technical problems which are not described herein will be clearly understood by a person (hereinafter referred to as an ordinary technician) having ordinary skill in the technical field, to which the present disclosure belongs, from the following description.

### Technical Solution

According to present disclosure, there is provided a video editing method capable of performing backup, the method including: loading original media selected as an editing target by a user into a clip setting area of a video project; creating trim media according to a trim request of the user for the original media loaded into the clip setting area; and storing the trim media as backup media, in response to a request to set storage of the backup media in the video project by the user.

According to the embodiment of the present disclosure in the method, the storing as the backup media may include storing a part of the original media corresponding to the created trim media as the backup media, in response to creation of the trim media using only at least a part of the original media by the trim request.

According to the embodiment of the present disclosure in the method, the original media may include at least one of a still image, a video or an audio. When the original media is a still image, the trim media may be set to a trim area of the still image spatially designated by the user in the original media. Also, when the original media is a video, the trim media may be set to a trim area of the video designated by the user for at least one of a time interval or a space in the original media.

According to the embodiment of the present disclosure in the method, at least a part of the original media may include all of the original media, and the storing as the backup media may include storing all of the original media as the backup media, in response to reception of a user's trim request indicating that all of the original media is created as the trim media.

According to the embodiment of the present disclosure in the method, the original media may be stored in a deletable memory area, and the backup media may be stored in a memory area different from the deletable memory area not to be deleted without additional manipulation of the user.

According to the embodiment of the present disclosure in the method, the generating the trim media may include creating additional content by performing editing to add content to the trim media by the request of the user, and the storing as the backup media may include storing trim media excluding the content as the backup media.

According to the embodiment of the present disclosure in the method, after the storing as the backup media, the method may further include: calling the video project including the trim media by the user; loading the trim media based on the backup media into the clip setting area when original media of the trim media is not stored; and setting an editable limit of media to a range of the backup media.

According to the embodiment of the present disclosure in the method, the method may further include: loading the trim media based on the original media into the clip setting area when original media of the trim media is stored; and setting an editable limit of the media to a range of the original media.

According to the embodiment of the present disclosure in the method, the method may further include: receiving a user's request to change media editing to change media editing; and updating and storing the media, the editing of which has changed, as the backup media.

According to the embodiment of the present disclosure in the method, after storing as the backup media, the method may further include: receiving a request to delete the video project or the trim media; and deleting all of backup media corresponding to all trim media of the video project in response to the request to delete the video project or deleting backup media corresponding to the trim media in response to the request to delete the trim media.

According to another present disclosure, there is provided a video editing device, the device including: a memory configured to store at least one instruction; a display configured to display media; and a processor configured to execute the at least one instruction stored in the memory. The processor is configured to: load original media selected as an editing target by a user into a clip setting area of a video project; create trim media according to a trim request of the user for the original media loaded into the clip setting area; and store the trim media as backup media, in response to a request to set storage of the backup media in the video project by the user.

According to another present disclosure, there is provided computer program stored in a recording medium readable by a computing electronic device in order to perform video editing method capable of performing backup, the method including: loading original media selected as an editing target by a user into a clip setting area of a video project; creating trim media according to a trim request of the user for the original media loaded into the clip setting area; and storing the trim media as backup media, in response to a request to set storage of the backup media in the video project by the user.

The features briefly summarized above for this disclosure are only exemplary aspects of the detailed description of the disclosure which follow, and are not intended to limit the scope of the disclosure.

### Effects of Invention

According to the present disclosure, it is possible to provide a video editing method, device, and computer program capable of storing backup media and use it in subsequent editing even if the original media used in an edited video is deleted.

According to the present disclosure, it is possible to reduce a memory capacity required for backup by storing at least a part of original media used in an edited video as backup media.

It will be appreciated by persons skilled in the art that that the effects that can be achieved through the present disclosure are not limited to what has been particularly described hereinabove and other advantages of the present disclosure will be more clearly understood from the detailed description.

### DESCRIPTION OF DRAWINGS

FIG. 1 is a diagram illustrating an electronic device to which various embodiments of the present disclosure are applied.

FIG. 2 is a diagram illustrating a system hierarchy structure of an electronic device to which various embodiments of the present disclosure are applied.

FIG. 3 is a flowchart illustrating a video editing method to which various embodiments of the present disclosure are applied.

FIG. 4 is a diagram illustrating an editing UI provided by a video editing UI control apparatus according to various embodiments of the present disclosure.

FIGS. 5A to 5E are diagrams illustrating a clip editing UI provided by a video editing UI according to various embodiments of the present disclosure.

FIG. 6 is a flowchart of a video editing method capable of performing backup according to an embodiment of the present disclosure.

FIGS. 7A to 7D are diagrams illustrating various examples of creating trim media performed according to a trim request.

FIG. 8 is a diagram illustrating an example of backing up trim media to a memory.

FIG. 9 is a flowchart of a video editing method capable of performing backup according to another embodiment of the present disclosure.

FIG. 10 is a diagram illustrating an example of backing up trim media by performing the video editing method according to FIG. 9.

FIG. 11 is a flowchart illustrating a process of deleting backup media.

### DETAILED DESCRIPTION

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

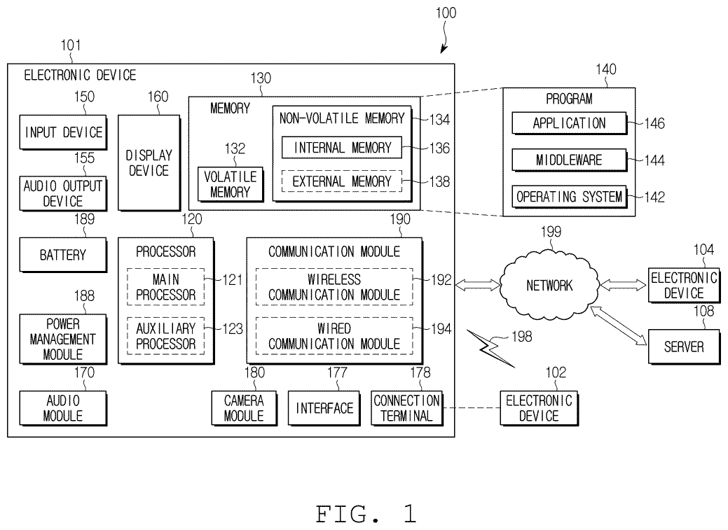

Various embodiments of the present disclosure may be implemented in an electronic device including a communication module, a memory, a display device (or display), and a processor, and a video editing device according to an embodiment of the present disclosure may be implemented by an electronic device (e.g., 101, 102, and 104 in FIG. 1) having an editing application embedded therein. According to the present disclosure, the electronic device may be a type of computing device according to the present disclosure. For convenience of description, in the present disclosure, an editing application is described as an example of a content editing application or a video (or image) editing application. Content may include not only videos and images, but also various types of media objects, such as audio, voice, music, text, and graphics. Also, the video editing device may be implemented by an electronic device having an image processing unit and a controller capable of processing videos (or images) and subtitle data.

Preferably, an electronic device to which various embodiments of the present disclosure are applied means a portable electronic device. The electronic device may be a user device, and the user device may be various types of devices such as, for example, a smartphone, a tablet PC, a laptop, and a desktop.

FIG. 1 is a block diagram illustrating an electronic device 101 in a network environment 100, as a diagram illustrating an electronic device to which various embodiments of the present disclosure are applied. Here, the electronic device 101 may be referred to as a computing device, and the electronic device 101 may have a built-in content editing application or an application downloaded from the outside and installed therein.

Referring to FIG. 1, in the network environment 100, the electronic device 101 communicates with an electronic device 102 through a first network 198 (e.g., short-range wireless communication), or communicate with an electronic device 104 or a server 108 through a second network 199 (e.g., a long-distance wireless communication). According to an embodiment, the electronic device 101 may communicate with the electronic device 104 through the server 108. According to an embodiment, the electronic device 101 may include a processor 120, a memory 130, an input device 150, an audio output device 155, a display device 160, an audio module 170, and an interface 177, a camera module 180, a power management module 188, a battery 189, a communication module 190 for transmitting and receiving data through networks 198 and 199, and the like. In another embodiment, in the electronic device 101, at least one of these components (e.g., the display device 160 or the camera module 180) may be omitted or another component may be added.

The processor 120 may for example, drive software (e.g., program 140) to control at least one other component (e.g., hardware or software component) of the electronic device 101 connected to the processor 120 and perform various data processing and calculations. The processor 120 may load and process commands or data received from another component (e.g., the communication module 190) into a volatile memory 132, and store resultant data in a non-volatile memory 134. According to an embodiment, the processor 120 may include a main processor 121 (e.g., a central processing unit or an application processor) and an auxiliary processor 123 that operates independently of the main processor 121. For example, the auxiliary processor 123 may be additionally or alternatively mounted on the main processor 121 to use less power than the main processor 121. As another example, the auxiliary processor 123 may include an auxiliary processor 123 (e.g., a graphic processing unit, an image signal processor, a sensor hub processor, or a communication processor) specialized for a designated function. Here, the auxiliary processor 123 may be operated separately from or embedded in the main processor 121.

In this case, the auxiliary processor 123 may for example, control at least some of functions or states related to at least one (e.g., the display device 160 or the communication module 190) of the components of the electronic device 101 in place of the main processor 121, while the main processor 121 is in an inactive (e.g., sleep) state. As another example, while the main processor 121 is in an active (e.g., application execution) state, the auxiliary processor 123, along with the main processor 121, may control at least some of functions or states related to at least components of the electronic device 101.

According to an embodiment, the auxiliary processor 123 (e.g., an image signal processor or a communication processor) may be implemented as a part of another functionally related component (e.g., the camera module 180 or the communication module 190). The memory 130 may store various data, for example, software (e.g., program 140), used by at least one component of the electronic device 101 (e.g., the processor 120) and input data or output data for commands related thereto. The memory 130 may include a volatile memory 132 or a non-volatile memory 134. The non-volatile memory 134 may be, for example, an internal memory 136 mounted in the electronic device 101 or an external memory 138 connected through an interface 177 of the electronic device 101. Original media, such as images captured by the camera module 180 and images obtained from the outside, video projects created through editing applications, and related data are allocated to and stored in at least one some areas of the internal and/or external memories 136 and 138 by settings of the electronic device 101 or according to user requests.

The program 140 is software stored in the memory 130, and may include, for example, an operating system 142, middleware 144, or an application 146. The application 146 may include a plurality of software for various functions, and may have a content editing application according to the present disclosure. The editing application is executed by the processor 140 and may be software that creates and edits a new video or selects and edits an existing video. In this disclosure, the application 146 is described separately from the program 140. However, since the operating system 142 and the middleware 144 are generally regarded as a kind of program that generally controls the electronic device 101, the program 140 may be commonly used without distinction from the application 146 from a narrow point of view. For convenience of description, a computer program that implements a video editing method capable of performing backup according to the present disclosure may be referred to as an application 146, and in the present disclosure, the program 140 may be used interchangeably with the application for performing the video editing method from a narrow point of view.

The input device 150 is a device for receiving a command or data to be used in a component (e.g., the processor 120) of the electronic device 101 from the outside (e.g., a user) of the electronic device 101, and may include, for example, a microphone, a mouse or a keyboard.

The audio output device 155 may be a device for outputting a sound signal to the outside of the electronic device 101. For example, the audio output device 155 may include a speaker used for general purposes such as playing multimedia or recording, and a receiver used exclusively for receiving calls. According to one embodiment, the receiver may be formed integrally with or separately from the speaker.

The display device 160 may be a display (or display device) for visually providing information to the user of the electronic device 101. The display device 160 may include, for example, a screen provision device for two-dimensionally displaying an image, a hologram device, or a projector and a control circuit for controlling the device. According to an embodiment, the display device 160 may function not only as an image output interface but also as an input interface for receiving user input. The display device 160 may include, for example, a touch circuitry or a pressure sensor capable of measuring the strength of a touch pressure. The display device 160 may detect the coordinates of a touch input area, the number of touch input areas, a touch input gesture, etc. based on the touch circuitry or the pressure sensor, and transmit the detected result to the main processor 121 or the auxiliary processor 123.

The audio module 170 may convert bidirectionally sound and electrical signals. According to an embodiment, the audio module 170 may obtain sound through the input device 150 or output sound through an external electronic device (e.g., an electronic device 102 (e.g., speaker or headphone)) connected to the electronic device 101 by wire or wirelessly.

The interface 177 may support a designated protocol capable of connecting to an external electronic device (e.g., the electronic device 102) by wired or wirelessly. According to one embodiment, the interface 177 may include a high definition multimedia interface (HDMI), a universal serial bus (USB) interface, an SD card interface, or an audio interface.

A connection terminal 178 is a connector capable of physically connecting the electronic device 101 and the external electronic device (e.g., the electronic device 102), for example, an HDMI connector, a USB connector, an SD card connector, or an audio connector (e.g., headphone connector).

The camera module 180 may capture still images and videos. According to one embodiment, the camera module 180 may include one or more lenses, image sensors, image signal processors, or flashes.

The power management module 188 is a module for managing power supplied to the electronic device 101, and may be configured as at least a part of a power management integrated circuit (PMIC).

The battery 189 is a device for supplying power to at least one component of the electronic device 101, and may include, for example, a non-rechargeable primary battery, a rechargeable secondary battery, or a fuel cell.

The communication module 190 may support establishment of a wired or wireless communication channel between the electronic device 101 and the external electronic device (e.g., the electronic device 102, the electronic device 104, or the server 108) and performance of data communication through the established communication channel. The communication module 190 may include one or more communication processors that support wired communication or wireless communication that are operated independently of the processor 120 (e.g., an application processor). According to an embodiment, the communication module 190 includes a wireless communication module 192 (e.g., a cellular communication module, a short-range wireless communication module, or a global navigation satellite system (GNSS) communication module) or a wired communication module 194 (e.g., a local area network (LAN) communication module or a power line communication module), and, using a corresponding communication module among them, may communicate with the external electronic device through a first network 198 (e.g., a short-range communication network such as Bluetooth, Bluetooth low energy (BLE), Wi-Fi direct, or infrared data association (IrDA)) or a second network 199 (e.g., a long-distance network such as a cellular network, the Internet, or a computer network (e.g., LAN or WAN)). The above-described various types of the communication modules 190 may be implemented as a single chip or may be implemented as separate chips.

Some of the above components may be connected to each other through a communication method between peripheral devices (e.g., a bus, GPIO (general purpose input/output), SPI (serial peripheral interface), or MIPI (mobile industry processor interface)) to exchange signals (e.g., commands or data) with each other.

According to an embodiment, commands or data may be transmitted or received between the electronic device 101 and the external electronic device 104 through the server 108 connected to the second network 199. Each of the electronic devices 102 and 104 may be the same as or different from the electronic device 101. According to an embodiment, at least some of the operations executed in the electronic device 101 may be executed in another or a plurality of external electronic devices. According to an embodiment, when the electronic device 101 needs to perform a specific function or service automatically or upon request, the electronic device 101 may request at least some functions associated with the function or service from the external electronic device instead of or additional to executing the function or service by itself. The external electronic device, which has received the request, may execute the requested function or additional function and deliver the result to the electronic device 101. The electronic device 101 may provide the requested function or service by processing the received result without change or additionally. To this end, for example, cloud computing, distributed computing, or client-server computing technology may be used.

The server 108 may transmit a content editing application according to the request of the electronic device 101 and control the electronic device 101 to implement the application. When the application is executed, the server 106 may exchange data with the electronic device 101, and support the electronic device 101 to perform the video editing method capable of performing backup according to the present disclosure. In this regard, the server 106 may be a type of computing device according to the present disclosure.

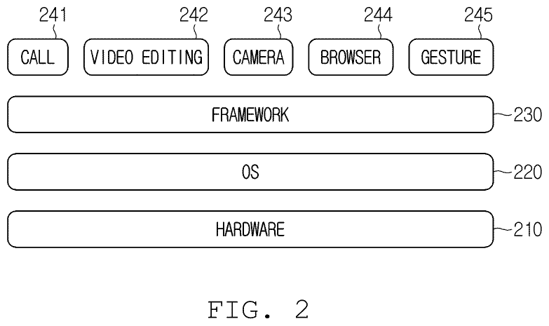

FIG. 2 is a diagram for explaining a system hierarchy structure of an electronic device to which various embodiments of the present disclosure are applied.

Referring to FIG. 2, an electronic device 200 may include a hardware layer 210 corresponding to the electronic device 101 of FIG. 1 described above, and an operating system (OS) layer 220 that manages the hardware layer 210 as a higher layer of the hardware layer 210, a framework layer 230 as a higher layer of the OS layer 220, and application layers 241 to 245.

The OS layer 220 controls overall operations of the hardware layer 210 and performs a function of managing the hardware layer 210. That is, the OS layer 220 is in charge of basic functions such as hardware management, memory, and security. The OS layer 220 may include drivers for operating or driving hardware devices included in the electronic device, such as a display driver for driving a display device, a camera driver for driving a camera module, and an audio driver for driving an audio module. In addition, the OS layer 220 may include a library and a runtime that developers may access.

The framework layer 230 exists as a higher layer of the OS layer 220, and the framework layer 230 serves to connect the application layers 241 to 245 and the OS layer 220. That is, the framework layer 230 includes a location manager, a notification manager, and a frame buffer for displaying an image on the display unit.

The application layers 241 to 245 implementing various functions of the electronic device 101 is located above the framework layer 230. For example, the application layers 241 to 245 may include various application programs such as a call application 241, a video editing application 242, a camera application 243, a browser application 244, and a gesture application 245.

Furthermore, the OS layer 220 may provide a menu or UI capable of adding or deleting at least one application or application program included in the application layers 241 to 245, and through this, at least one application or application program included in the application layers 241 to 245 may be added or deleted by the user. For example, as described above, the electronic device 101 of FIG. 1 maybe connected to the other electronic devices 102 and 104 or the server 108 through communication, and may receive data (that is, at least one application or application program) provided from the other electronic devices 102 and 104 or the server 108 by the request of the user and store it in the memory. At this time, at least one application or application program stored in the memory may be configured and operated in the application layers 241 to 245. In addition, at least one application or application program may be selected by the user using the menu or UI provided by the OS layer 220, and the selected at least one application or application program may be deleted.

Meanwhile, when a user control command input through the application layers 241 to 245 is input to the electronic device 101, it may be transferred from the application layers 241 to 245 to the hardware layer 210 to execute a specific application corresponding to the input control command, and the result may be displayed on the display device 160.

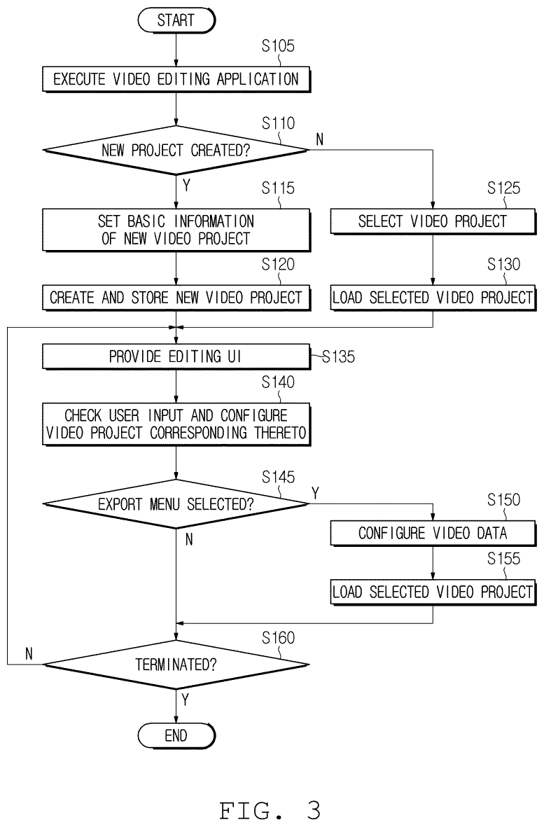

FIG. 3 is a flowchart illustrating a video editing method to which various embodiments of the present disclosure are applied. In FIG. 3, the content editing application is described as a video editing application.

Referring to FIG. 3, first, the video editing method may be operated by the above-described electronic device (or computing device), and the operation may be initiated as a video editing application is selected and executed by user input (S105).

When the video editing application is executed, the electronic device may output an initial screen of the video editing application to a display device (e.g., a display). A menu (or UI) for creating a new video project and a video project selection menu (or UI) for selecting a video project being edited in advance may be provided on the initial screen. On this initial screen, when the menu (or UI) for creating the new video project is selected by the user, the process may proceed to step S115, and when the video project selection menu (or UI) is selected, the process may proceed to step S125 (S110).

In step S115, the electronic device 101 may provide a menu (or UI) for setting basic information of a new video project, and set and apply the basic information input through the menu (or UI) to the new video project. For example, the basic information may include an aspect ratio of the new video project. Based on this, the electronic device may provide a menu (or UI) capable of selecting an aspect ratio such as 16:9, 9:16, 1:1, etc., and an aspect ratio input through the menu (or UI) may be set and applied to the new video project.

Thereafter, the electronic device 101 may create a new video project by reflecting the basic information set in step S115, and store the created new video project in a storage medium (S120).

Although the aspect ratio is exemplified as basic information in embodiments of the present disclosure, the present disclosure is not limited thereto, and may be variously changed by a person having ordinary knowledge in the technical field of the present disclosure. For example, the electronic device 101 may provide a menu (or UI) capable of setting at least one of automatic control of a master volume, the size of the master volume, audio fade-in default setting, audio fade-out default settings, video fade-in default settings, video fade-out default settings, default settings of an image clip, default settings of a layer length or pan&zoom default settings of the image clip, and a value input through the menu (or UI) may be set as the basic information of the new video project.

As another example, the electronic device 101 may automatically set the aspect ratio, automatic control of the master volume, the size of the master volume, the audio fade-in default settings, the audio fade-out default settings, the video fade-in default settings, the video fade-out default settings, the default settings of the image clip, the default settings of the layer length, and the pan&zoom default settings of the image clip to predetermined values. In addition, the electronic device 101 may provide a setting menu (or UI), receive control values of the aspect ratio, automatic control of the master volume, the size of the master volume, the audio fade-in default settings, the audio fade-out default settings, the video fade-in default settings, the video fade-out default settings, the default settings of the image clip, the default settings of the layer length, and the pan & zoom default settings of the image clip through the setting menu (or UI), and set the above-described default information according to the received values.

Meanwhile, in step S115, the electronic device 101 may provide a project list including video projects stored in a memory 130 and provide an environment in which at least one video project included in the project list may be selected. Through the above-described environment, the user may select at least one video project included in the project list (S130), and the electronic device 101 may load the at least one video project selected by the user (S135).

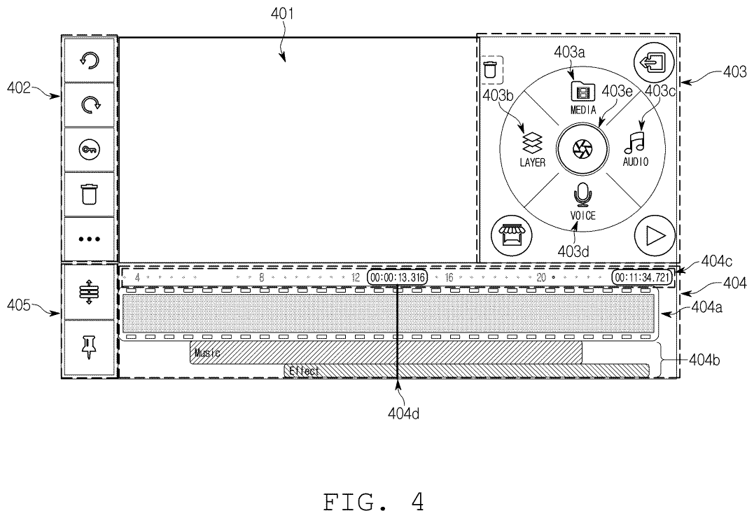

In step S135, the electronic device 101 may provide an editing UI. As shown in FIG. 4, the editing UI may include a video display window 401, a media setting window 402, a media input window 403, a clip display window 404, a clip setting window 405, and the like. In the editing UI, the video display window, the media setting window, and the media input window may be displayed on an upper portion of the display, and the clip display window and the clip setting window may be displayed on a lower portion of the display.

The media setting window may include an export menu, a capture menu, a setting menu, and the like, and the export menu, the capture menu, and the setting menu may be provided in the form of icons or text capable of recognizing the corresponding menu.

The media input window may include a media input menu 403a, a layer input menu 403b, an audio input menu 403c, a voice input menu 403d, a shooting menu 403e, and the like, and the media input menu 403a, the layer input menu 403b, the audio input menu 403c, the voice input menu 403d, and the shooting menu 403e may be provided in the form of icons or text capable of recognizing the corresponding menu. Also, each menu may include a sub-menu, and as each menu is selected, the electronic device 101 may compose and display a sub-menu corresponding thereto.

For example, the media input menu 403a may be connected to the media selection window as a sub-menu, and the media selection window may provide an environment capable of selecting media stored in the memory 130, for example, original media created by the user and received from another source. Media selected through the media selection window may be inserted and displayed in the clip display window. The electronic device 101 may check the type of media selected through the media selection window, set the clip time of the media in consideration of the checked type of the media, insert and display it in the clip display window. Here, the type of media may include images, videos, and the like. If the type of media is an image, the electronic device 101 may check a default length setting value of the image clip and set an image clip time according to the default length setting value of the image clip. In addition, if the type of media is a video, the electronic device 101 may set the time of the video clip according to the length of the corresponding media.

As a sub-menu of the layer input menu 403b, a media input menu, an effect input menu, an overlay input menu, a text input menu, a media input menu, and a drawing input menu may be included.

The media input menu may be configured in the same way as the aforementioned media input menu.

The effect input menu may provide an environment in which blur effect, mosaic effect, noise effect, sandstorm effect, melting point effect, crystal effect, star filter effect, display board effect, haze effect, fisheye lens effect, magnifying lens effect, flower twist effect, night vision effect, sketch effect, etc. may be selected. An effect selected through the effect input menu may be inserted and displayed in the clip display window. At this time, the electronic device may check the default setting value of the layer length and set the effect clip time according to the default setting value of the layer length.

The overlay input menu may provide an environment in which stickers and icons of various shapes or shapes may be selected. The stickers, icons, etc. selected through the overlay input menu may be inserted and displayed in the clip display window. At this time, the electronic device may check the default setting value of the layer length and set the clip times of stickers, icons, etc. according to the default setting value of the layer length.

The text input menu may provide an environment in which text may be input, for example, a Qwerty keyboard. The text input through the text input menu may be inserted and displayed in the clip display window. At this time, the electronic device may check the default setting value of the layer length and set the text clip time according to the default setting value of the layer length.

The drawing input menu may be configured to provide a drawing area in the image display window and to display a drawing object in a touch input area in the image display window. The handwriting input menu may include a drawing tool selection menu for selecting a drawing tool, a color selection menu for selecting a drawing color, a thickness setting menu for setting the thickness of a drawing object, a partial deletion menu for deleting a created drawing object, and a delete-all menu for deleting all drawn objects as sub-menus. In addition, when the handwriting input menu is selected, the electronic device may check the default setting value of the layer length and set the drawing object clip time according to the default setting value of the layer length.

The audio input menu 403c may be connected to the audio selection window as a sub-menu, and the audio selection window may provide an environment in which an audio file stored in a storage medium may be selected. An audio file selected through the audio selection window may be inserted and displayed in the clip display window.

The voice input menu 403d may be a menu for recording sound input through a microphone. When the voice input menu is selected by the user, the electronic device may activate the microphone provided in the device to detect a voice signal input through the microphone. In addition, the electronic device may display a recording start button, and when the recording start button is input, recording of the voice signal may be started. Furthermore, the electronic device may visualize and display the voice signal input through the microphone. For example, the electronic device may check the amplitude or frequency characteristics of the voice signal and display the checked characteristics in the form of a level meter or a graph.

The shooting menu 403e may be a menu for capturing an image or video input through a camera module included in the electronic device 101. The shooting menu 403e may be displayed through an icon visualizing a camera device. The shooting menu 403e may include an image/video shooting selection menu for selecting a camera for capturing an image or a camcorder for capturing a video as a sub-menu thereof. Based on this, when the shooting menu 403e is selected by the user, the electronic device may display an image/video shooting selection menu. In addition, the electronic device may activate an image capturing mode or a video capturing mode of the camera module according to selection through the image/video capturing selection menu.

The clip display window 404 may include at least one clip line displaying a clip corresponding to media, effect, overlay, text, drawing, audio, voice signal, etc. input through the media input window.

The clip line may include a main clip line 404a and a sub clip line 404b, and a clip line provided at the uppermost end of the clip display window is referred to as the main clip line 404a, and at least one clip line provided under the main clip line 404a may be referred to as the sub clip line 404b.

The electronic device may fix and display the main clip line 404a at the uppermost end of the clip display window, check drag input based on an area where the sub clip line 404b exists, and scroll the sub clip line 404b up and down according to a drag input direction.

Furthermore, when the drag input direction is checked as an upward direction, the electronic device 101 may move and display the sub clip line 404b to an upper area, and when the drag input direction is checked as a downward direction, the electronic device may move and display the sub clip line 404b to a lower area. In addition, the electronic device may display the height of the main clip line 404a differently according to the movement of the sub clip line 404b. For example, when the sub clip line 404b moves upward, the height of the main clip line 404a may be decreased and displayed, and when the sub clip line 404b moves downward, the height of the main clip line 404a may be increased and displayed.

In particular, the clip display window 404 may include a time display line 404c indicating the time of the video project and a play head 404d. The time display line 404c may be displayed above the main clip line 404a described above, and may include a scale or number in a predetermined unit. In addition, the play head 404d may be displayed as a line starting from the time display line 404c and vertically connected to the lower end of the clip display window, and may be displayed in a color (e.g., red) that can be easily recognized by the user.

Furthermore, the play head 404d may be provided in a fixed form in a predetermined area, and the objects included in the main clip line 404a and the sub clip line 404b provided in the clip display window and the time display line 404c may be configured to be movable in the left and right directions.

For example, when drag input is generated in the left and right directions in an area where the main clip line 404a, the sub clip line 404b, and the time display line 404c are located, the electronic device may move and display the objects included in the main clip line 404a and the sub clip line 404b and the time display line 404c in the left and right directions. In this case, the electronic device may be configured to display a frame or object corresponding to the play head 404d in the image display window. In addition, the electronic device 101 may check a detailed time (e.g., in units of 1/1000 second) that the play head 404d touches, and display the checked detailed time together in the clip display window.

In addition, the electronic device 101 may check whether a multi-touch has occurred in the clip display window 404, and if a multi-touch has occurred, a scale or number of a predetermined unit included in the time display line 404c may be changed and displayed in response to the multi-touch. For example, when input in which a multi-touch interval gradually decreases is confirmed, the electronic device may decrease the interval between scales or numbers. When input in which the multi-touch interval gradually increases is confirmed, the electronic device may increase and display the interval between scales or numbers.

The electronic device may configure the clip display window 404 so that a clip displayed on the clip line may be selected, and when a clip is selected, it may visualize and display that the corresponding clip has been selected. For example, when selection of a clip is detected, the electronic device may provide a clip selector to a boundary of the selected clip, and the clip selector maybe displayed in a predetermined color, for example, yellow.

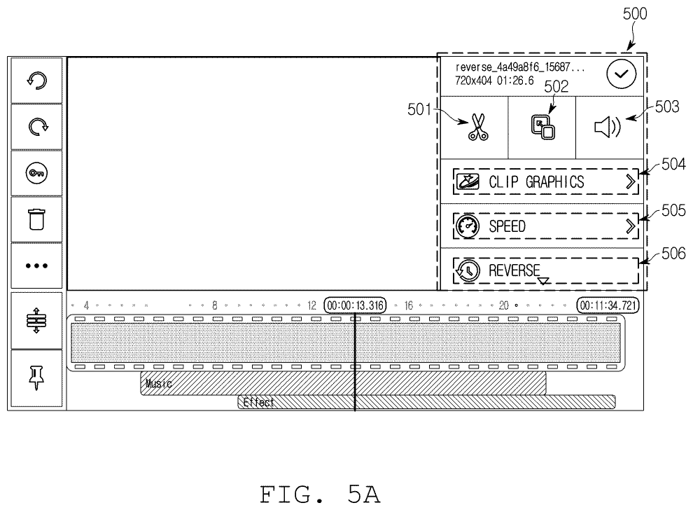

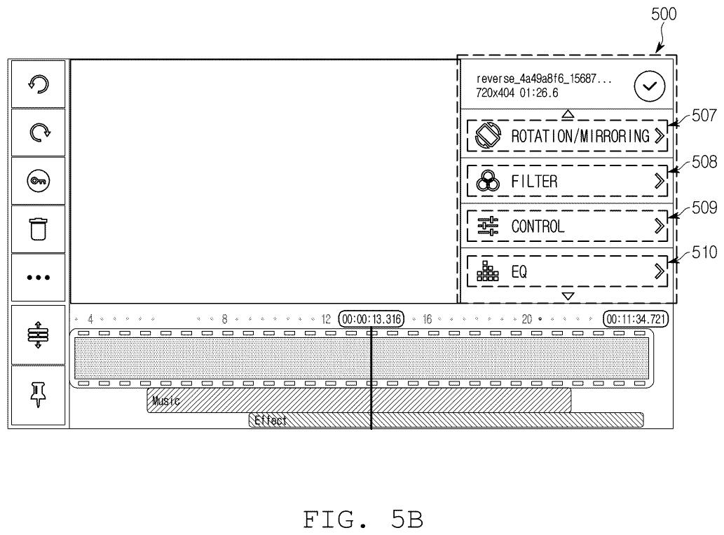

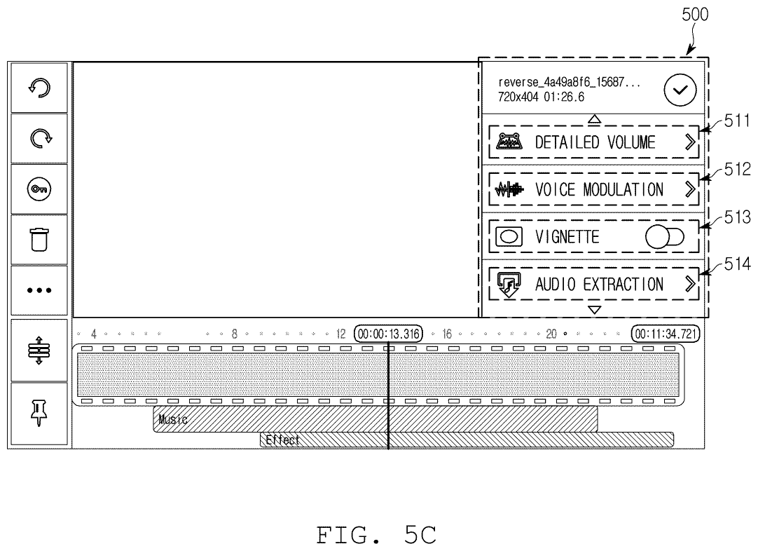

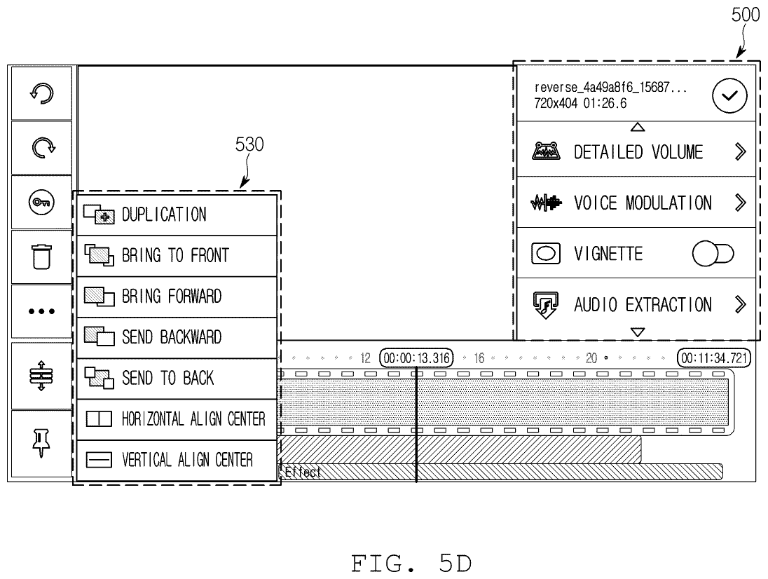

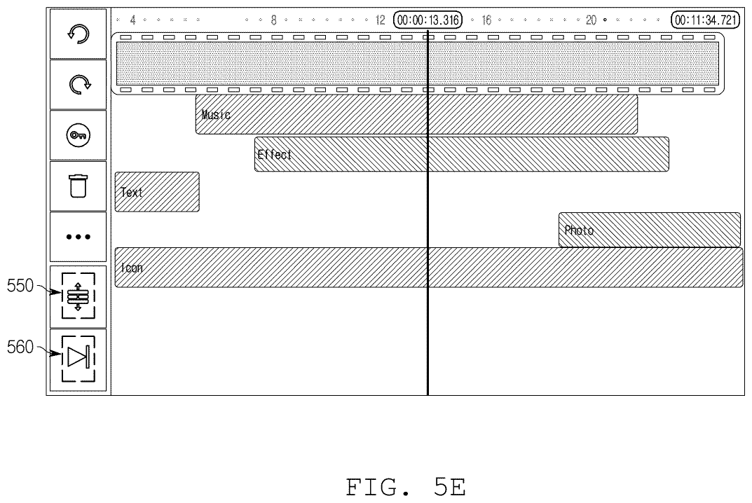

Preferably, when selection of a clip is detected, the electronic device may provide a clip editing UI capable of editing the selected clip. For example, the electronic device may display a clip editing UI in an area where the media input window 403 exists, as shown in FIGS. 5A to 5D. The clip editing UI may be set differently according to the type of the selected clip. Specifically, when the type of clip is a video clip, the electronic device may configure and provide a clip editing UI 500, by including a trim/split menu 501, a pan/zoom menu 502, an audio control menu 503, a clip graphic menu 504, and a speed control menu 505, a reverse control menu 506, a rotation/mirroring control menu 507, a filter menu 508, a brightness/contrast control menu 509, a voice EQ control menu 510, a detailed volume control menu 511, a voice modulation menu 512, a vignette control menu 513, an audio extraction menu 514, and the like.

The clip editing UI for each type of clip may be configured based on the structure of the video editing UI.

Additionally, the electronic device 101 may further display a clip editing expansion UI 530 in an area where the media setting window exists. The clip editing expansion UI displayed in the area of the media setting window may also be set differently according to the type of the selected clip. For example, when the type of clip is a video clip, an image clip, an audio clip, or an audio signal clip, the electronic device may configure and provide the clip editing expansion UI 530 by including a clip deletion menu, a clip duplication menu, a clip layer duplication menu, and the like. If the type of clip is a video clip, image clip, audio clip, or audio signal clip, the electronic device may configure and provide the clip editing expansion UI 530 by including the clip deletion menu, the clip duplication menu, the clip layer duplication menu, and the like, and if it is an effect clip, text clip, overlay clip, or drawing clip, the electronic device may configure and provide the clip editing expansion UI by including a clip deletion menu, a clip duplication menu, a bring-to-front menu, a bring-forward menu, a send-backward menu, a send-to-back menu, a horizontal align center menu, a vertical align center menu and the like.

The clip setting window may include a clip enlargement display menu 550 and a clip movement control menu 560, as shown in FIG. 5E. When the clip display menu 550 is selected by the user, the electronic device may enlarge and display the clip display window to the entire area of the display. Also, when the clip movement control menu 560 is selected, the electronic device may move and display the clip according to the play head. Furthermore, the clip movement control menu 560 may include a start area movement menu or an end area movement menu, and it is preferable that the start area movement menu or end area movement menu may be adaptively displayed in consideration of the position of the play head touching the clip. For example, the electronic device basically provides the start area movement menu, and when a clip touches a starting position of the play head, the start area movement menu may be replaced with the end area movement menu and displayed.

In step S140, the electronic device may check user input input through the editing UI, configure a video project corresponding to the user input, and store the configured video project in a storage medium.

As described above, the editing UI is configured to include an export menu in the media setting window. When the export menu is selected by the user (Y in S145), the electronic device 101 may configure video data by reflecting the information configured in the video project and store it in a memory 130 (S150).

In addition, the electronic device 101 may upload the edited video and project to a shared video service-related device according to the request of a user at the same time as or after the video data is stored through the export menu.

The structure of the editing UI provided by the apparatus for controlling the video editing UI according to various embodiments of the present disclosure may be configured as follows.

First of all, as shown in FIG. 4, the editing UI may basically include a video display window 401, a media setting window 402, a media input window 403, a clip display window 404, a clip setting window 405, and the like. At least one clip selected through the media input window 403 may be displayed on the clip display window 404. In addition, as at least one clip 404a or 404b included in the clip display window 404 is selected, as shown in FIGS. 5A to 5D, clip editing menus 501 to 514 may be provided in the area where the media input window 403 exists. At this time, the clip editing menus 501 to 514 may be provided adaptively according to the structure of the editing UI for each clip type.

The video clip editing menu may include a trim/split menu, a pan/zoom menu, an audio control menu, a clip graphic menu, a speed control menu, a reverse control menu, a rotation/mirroring menu, a filter menu, a brightness/contrast/gamma control menu, a voice EQ control menu, a detailed volume control menu, a voice modulation control menu, a vignetting ON/OFF control menu, an audio extraction menu, and the like.

The trim/split menu may include a trim menu on the left of the play head, a trim menu on the right of the play head, a split menu on the play head, a still image split and insert menu, and the like, as sub-menus.

The audio control menu may include a master volume control bar, a sound effect volume control bar, an automatic volume ON/OFF menu, a left/right balance control bar, a pitch control bar, and the like, as sub-menus. In addition, the master volume control bar, the sound effect volume control bar, the left/right balance control bar, the pitch control bar, and the like may be set to support a detailed control UI, and the master volume control bar, the sound effect volume control bar, the left/right balance control bar, the pitch control bar and the like may be managed through the main editing UI. A UI set as the main editing UI may be configured to display a detailed control UI together. As another example, when touch input is generated for more than a predetermined time (e.g., 1 second) in an area where the main editing UI set to support the detailed control UI exists, the detailed control UI may be activated as a sub-menu.

The clip graphic menu may be configured to select at least one graphic to be inserted into the clip.

The speed control menu may include at least one predetermined speed control button (e.g., 1×, 4×, 8×), a speed control bar, a mute ON/OFF menu, a pitch maintenance ON/OFF menu, and the like. Also, the speed control bar may be managed as a main editing UI.

The reverse control menu may be configured to perform reverse processing of a video included in a corresponding clip.

The voice EQ control menu may be configured to select at least one voice EQ to be applied to a video.

The filter menu may be configured to select at least one video filter to be applied to the video.

The brightness/contrast/gamma control menu may include a brightness control bar, a contrast control bar, a gamma control bar and the like as sub-menus so as to control the brightness/contrast/gamma value of the video, and the brightness control bar, the contrast control bar, and the gamma control bar and the like may be managed as a main editing UI and set to support the detailed control UI.

The rotation/mirroring menu may include a horizontal mirroring menu, a vertical mirroring menu, a counterclockwise rotation menu, a clockwise rotation menu and the like as sub-menus, and the counterclockwise rotation menu and clockwise rotation menu may be managed as a main editing UI and set to support the detailed control UI.

The detailed volume control menu is a menu for controlling the volume of audio included in the video, and may include a control point addition menu, a control point deletion menu, a voice control bar and the like. The voice control bar may be managed as a main editing UI and set to support the detailed control UI.

The voice modulation control menu may be configured to select at least one voice modulation method to be applied to the video.

Meanwhile, the image clip editing menu may include a trim/split menu, a pan/zoom menu, a rotation/mirroring control menu, a clip graphic menu, a filter menu, a brightness/contrast/gamma control menu, a vignetting ON/OFF control menu, and the like.

In addition, the effect clip editing menu may include an effect setting menu, a transparency control menu, a trim/split menu, a rotation/mirroring control menu, and the like, and the trim/split menu, the rotation/mirroring control menu and the like may be configured similarly to the video clip editing menu. In addition, the effect setting menu and the transparency control menu may include an effect setting bar and a transparency control bar, respectively, as sub-menus, and the effect setting bar and the transparency control bar may be managed as a main editing UI and set to support the detailed control UI.

The overlay clip editing menu may include an overlay color setting menu, a transparency control menu, a trim/split menu, a rotation/mirroring control menu, a blending type setting menu, and the like. The trim/split menu, the rotation/mirroring control menu and the like may be configured similarly to the video editing menu. Also, the transparency control menu may include a transparency control bar as a sub-menu, and the transparency control bar may be managed as a main editing UI and set to support the detailed control UI.

In addition, the text clip editing menu may include a text font setting menu, a text color setting menu, a trim/split menu, a transparency control menu, a rotation/mirroring control menu, a text alignment method setting menu, a shadow ON/OFF menu, a glow ON/OFF menu, an outline ON/OFF menu, a background color ON/OFF menu, a blending type setting menu, and the like, and the trim/split menu, the transparency control menu, the rotation/mirroring control menu, and the like may be configured similarly to the video clip editing menu. In addition, the shadow ON/OFF menu, the glow ON/OFF menu, the outline ON/OFF menu, and the background color ON/OFF menu may respectively include a color control bar (e.g., R/G/B control bar) for setting a color or a transparency control bar for controlling transparency as sub-menus, and the color control bar (e.g., R/G/B control bar) or the transparency control bar may be managed as a main editing UI and set to support the detailed control UI.

In addition, the drawing clip editing menu may include a transparency control menu, a trim/split menu, a rotation/mirroring control menu, a blending type setting menu, and the like, and the trim/split menu, the rotation/mirroring control menu and the like may be configured similarly to the overlay clip editing menu. Also, the transparency control menu may include a transparency control bar as a sub-menu, and the transparency control bar may be managed as a main editing UI and set to support the detailed control UI.

In addition, the audio clip editing menu may include an audio control menu, a voice EQ control menu, a detailed volume control menu, a voice modulation control menu, a ducking ON/OFF control menu, a repeat ON/OFF control menu, a trim/split menu, and the like. The audio control menu, the voice EQ control menu, the detailed volume control menu, the voice modulation control menu, the trim/split menu, and the like may be configured similarly to a video clip editing menu.

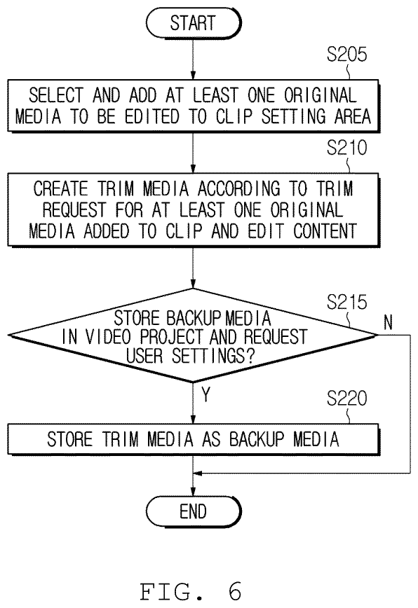

FIG. 6 is a flowchart of a video editing method capable of performing backup according to an embodiment of the present disclosure. For example, the process of FIG. 6 proceeds after steps S110 and S115 of FIG. 3, and may proceed as the detailed process of step S120.

First, a user selects original media as an editing target using a video editing application, and the processor 120 may load the selected original media into the video display window 401 and the clip display window 404 of the video project (S205). The original media may include at least one of still images, moving images, or audio. In the present disclosure, the clip display window 404 may be an example of a clip setting area.

The clip display window 404 may set a clip related to the original media as an initial main clip and load the initial main clip into the main clip line 404a illustrated in FIG. 4. The main clip line 404a may express original media related to the initial main clip in frames at predetermined intervals. In addition, the user may select other original media following the initial main clip and add another initial main clip to the main clip line 404a. In this disclosure, for convenience of explanation, the main clip loaded in the main clip line 404a will be described interchangeably with the original media or main media.

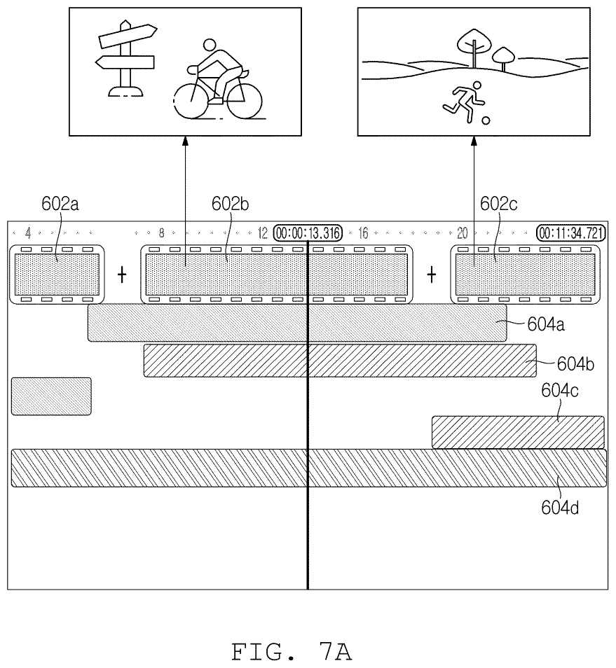

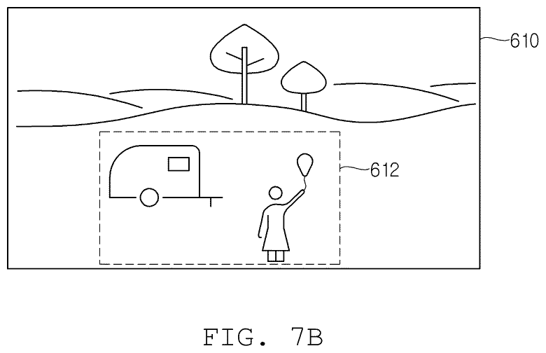

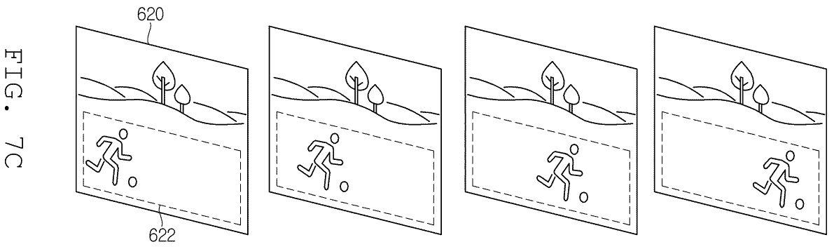

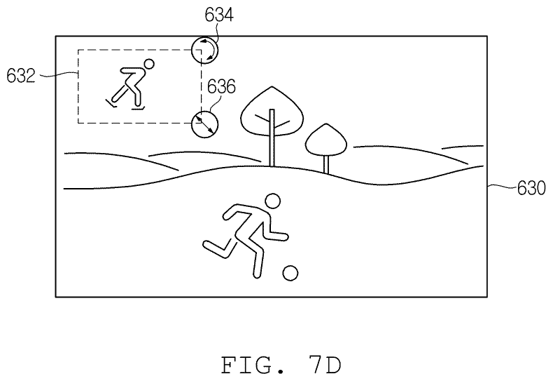

Next, as illustrated in FIG. 7A, according to a user's trim request for the original media loaded in the clip display window 404, the processor 120 may create trim media 602a to 602c (S210).

The trim media 602a to 602c may be media that is processed so that at least a part of the original media is selected according to the user's trim request and maintained as edited content of the project, and the unselected part is not included in the edited content. FIG. 7A illustrates a plurality of trim media 602a to 602c maintained by trimming the initial main clip, and the trim media 602a to 602c may be used interchangeably with main trim media or main clip in the present disclosure. In addition, for convenience of explanation in the present disclosure, the plurality of main trim media 602a to 602c may be referred to as first to third main trim media 602a to 602c, respectively.

The plurality of first to third main trim media 602a to 602c may be extracted from one original media, or may be created by sequentially combining media extracted from the plurality of original media.

When the original media 610 is a still image, as illustrated in FIG. 7B, the main trim media 612 may be set as a trim area of the still image spatially designated by the user in the original media. Spatial designation may be realized, for example, by a user's designated gesture for the original media 610 displayed on the image display window 401 and/or by manipulation of a tool related to space designation.

When the original media 620 is a video, as illustrated in FIG. 7C, the main trim media 622 may be set to the trim area of the video designated by the user for at least one of a time interval or space in the original media 622. To indicate that the original media 620 illustrated in FIG. 7C is a video, movement of an object is shown as being developed frame by frame.

The trim request related to the time interval selected by the user may be made, for example, by the user's gesture touch input on the provided initial main clip of the main clip line 404a and/or by manipulation using a trim tool. More specifically, by gesture touch input to adjust the window of the initial main clip of the main clip line 404a illustrated in FIG. 4 and/or by manipulation using a tool in the trim/split menu 501 illustrated in FIG. 5A, the user may retain at least part of the original media 620 in the edited content.

In addition, if the original media 620 related to each of the main trim media 602a to 602c is maintained, the user may re-edit each of the main trim media 602a to 602c. At this time, the processor 120 may provide the initial content of the original media 620 so that the user may check all of the original media 620. Specifically, even if each of the main trim media 602a to 602c is created by a primary trim request, the user may readjust the trim, such that other sections of the original media 620 that are not included in the main trim media 602a to 602c are included in the edited content or sections of the original media 620 that are already included are excluded. For example, the user adjusts the window of the main clip of each of the main trim media 602a to 602c provided in the clip display window 404, such that the processor 120 may provide the initial main clip including all of the original media 620. The user may check all of the original media 620 by the initial main clip. The user may re-execute the trim request in the initial main clip, such that the processor 120 may change the primarily created main trim media 602a to 602c. As another specific example, the user releases the tool of the trim/split menu 501 through which each of the main trim media 602a to 602c has been trimmed, such that the processor 120 may restore the original media 620 and recreate the main trim media according to a user's trim re-request.

The trim request related to the space of the area selected by the user, similarly to the spatial designation of the still image, may be made by the user's designated gesture for the original media 620 displayed in the video display window 401 and/or the manipulation of the tool related to space designation. The main trim media 622 according to a spatial trim request may also be re-edited, similarly to the above-described process.

A trim request with both time interval and space specified may be made by combining the above-described items.

In relation to trim of a video, the processor 120 may check at least one of a time interval, trim of which is requested by the user in the original media 620, and the start and end points of the interval. For example, the processor 120 may identify the I-Frame (Infra-Frame) of the original media 620 related to each point, and trim the original media 620 by employing the I-Frame as the trim start point. For the I-Frame, when a video is compressed, data at a previous time, for example, preceding video data, may be used. However, for the I-Frame, a video may be compressed without using preceding video data. Therefore, the video may start with the I-Frame and the I-Frame may be inserted at the midpoint of the video, so that the processor 120 may search for and play the video at that location.

If the trim processing is performed based on a point requested by the user, regardless of the I-Frame of the original media 620, the processor 120 shall perform transcoding to decode the original media 620 and re-encode it in a desired format. As in the embodiment of the present disclosure, when the original media 620 is trimmed using the I-Frame, the trim processing may be simply and rapidly implemented in a manner of deleting the video data before the I-frame without accompanying transcoding. The video data before the I-Frame may be deleted by, for example, modifying some metadata.

Meanwhile, the processor 120 may perform editing to add content to the main trim media 602a to 602c in response to a user's request to add content to the main trim media 602a to 602c. For example, elements constituting the content may be video frames, voices, music, effects, image frames, text, overlapped layers, etc. The added content may be sub media because it is added to the main trim media. It may be confirmed through the video display window 401, the audio output device 155, and the clip display window 404. The clip display window 404 may provide, for example, a sub clip line 404b as illustrated in FIG. 4, and the sub clip line 404b may present various information related to the added content. More specifically, the sub clip line 404b may visually provide sub clips 604a to 604d for each added content, as illustrated in FIGS. 4 and 7A. Content related to the sub clips 604a to 604d may be synthesized into the first to third main trim media 602a to 602c.

The user may re-edit the content of the sub clips 604a to 604d or adjust temporal and spatial overlap with the main trim media 602a to 602c. As illustrated in FIG. 7D, the user may perform edit using editing tools such as arrangement and size adjustment UIs 634 and 636 of the added content 632.

For example, if the added content 632 is a still image or a video obtained from another original media, the added content 632 may be placed to overlap a spatial part of the main trim media 630 according to the user's request, as illustrated in FIG. 7D. That is, as illustrated in FIG. 7D, the plurality of original media may be overlapped and edited.

In addition, depending on the attributes of the added content, the user may create sub trim media by requesting trim for at least part of the added content, similarly to the trim media described above. The sub trim media may be confirmed through the sub clip in the clip display window 404. The sub trim media may be a type of trim media, similarly to the main trim media 630. In the present disclosure, for convenience of explanation, the sub trim media may be used interchangeably with trim media, sub media, or sub clip. The sub media and the sub clip may be configured to include at least part of the original media. In addition, similarly to re-editing of the main trim media 630, if the original media is maintained, the user may re-edit the primarily created sub trim media 632. For example, the user may re-check the original media and add a part of the original media included in the primarily created sub trim media 632, or recreate the sub trim media 632 by a trim request to exclude a part of the included original media.

Specifically, the elements of content may include a media input menu 403a, a layer input menu 403b, an audio input menu 403c, a voice input menu 403d, and a shooting menu 403e, and may be a tool for decorating content mentioned in the media input menu 403a, the layer input menu 403b, the audio input menu 403c, the voice input menu 403d, and the shooting menu 403e.

Media and shooting may be images, videos, etc. that have been previously stored or taken. Effects may be blur effect, mosaic effect, noise effect, sandstorm effect, melting point effect, crystal effect, star filter effect, display board effect, haze effect, fisheye lens effect, magnifying glass lens effect, flower twist effect, night vision effect, sketch effect, etc. In addition, an overlay may be stickers or icons of various forms or shapes, and a drawing may be a drawing object that may be created in a drawing area that is touched by touch input in the video display window. Audio and voice may be a pre-stored audio file or a voice acquired from a microphone of an electronic device.

These elements may be temporally and spatially arranged and combined, thereby creating content. In addition, each element may be arranged and combined in an overlapping manner in a depth direction at the same time and in a two-dimensional space, and in this case, depth information between the elements may be included. The arrangement combination of the above-described elements may be referred to as a relationship between the elements of content in this specification.

If storage and use settings of backup media are requested in the video project (Y in S215), the processor 120 may store the trim media as backup media.

The settings may be determined by the user's request or the basic settings of the editing application. The user's request may be determined by basic information setting in step S115 of FIG. 3 or by a separate request in the project currently being edited.

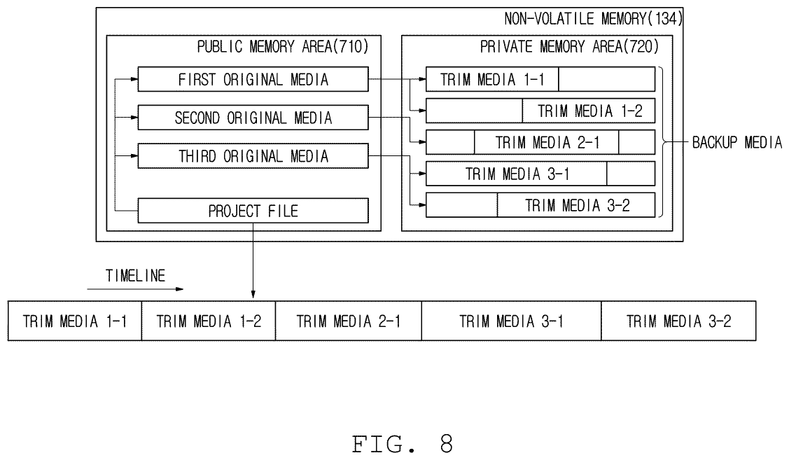

As an example, when trim media using only at least a part of the original media is created by the trim request, the processor 120 store, as backup media, at least a part of the first to third original media corresponding to the created trim media 1-1, 1-2, 2-1, 3-1 and 3-2, as shown in FIG. 8. Here, the first to third original media may be content loaded by the user in the form of an initial clip into at least one of the main clip line 404a or the sub clip line 404b. Accordingly, the trim media (1-1, 1-2, 2-1, 3-1 and 3-2 in FIG. 8) may be at least one of main or sub trim media.

The processor 120 may manage a series of trim media 1-1, 1-2, 2-1, 3-1 and 3-2 edited by the user in the project, extract a part of the first to third original media corresponding to each of the trim media based on each of the trim media 1-1, 1-2, 2-1, 3-1 and 3-2 and store the extracted original media as a backup image. Projects and backup images may be managed in separate areas of the memory 130, such as a public memory area 710 and a private memory area 720. When the project is called in step S125 of FIG. 3, the processor 120 may provide edited content in which the main and sub media are synthesized and the main and sub clip lines 404a and 404b, through the video display window 401 and the clip display window 404.

Storage of backup media will be described using a video as an example. When trim is performed using a middle time point of the video as a starting point, the processor 120 may process the video to start from the nearest I-Frame location before the start location requested by the user, and store the trim media related to the video processed based on the I-Frame location as backup media. When extracting a part of the original video corresponding to the trimmed video, the processor 120 may extract a part of the original video by referring to the I-Frame related to the trim start point of the video.

As another example, the processor 120 may extract only the original media related to the main trim media, excluding the original media related to the sub trim media, and store it as backup media. As described above, the sub trim media may be additional content added to and trimmed from the main trim media. The sub trim media may be excluded by a user's request or settings of the editing application, thereby reducing the resource burden on the memory 130.

As another example, when the processor 120 receives, from the user, a trim request to instruct creation of all of the original media as trim media, the processor 120 may store all of the original media as backup media. In this case, the original media may be related to at least one of main or sub media.

The original media and backup media are stored in the non-volatile memory 130 as shown in FIG. 8, but may be distributed and stored in memory areas with different attributes. Specifically, as shown in FIG. 8, the original media may be stored in a deletable memory area, for example, a public memory area 710, and the backup media may be stored in the private memory area 720 as a memory area different from the deletable memory area 310 so that it cannot be deleted without additional manipulation of the user. For example, the private memory area 720 may be a storage medium managing a folder of another path which may be managed by a folder or password that is not exposed in normal searches or may be only intentionally accessed by the user.

In the present embodiment, the backup media may be stored in various ways or at various points in time. For example, the backup of the trim media may be executed when the trim media is added to the project, or may be executed after confirming the trim media that requires backup at the end of the project in step S145 of FIG. 3. As another example, the backup of the trim media may be executed after checking the trim media that requires backup at predetermined time intervals, such as 1 minute or 5 minutes, during project editing.

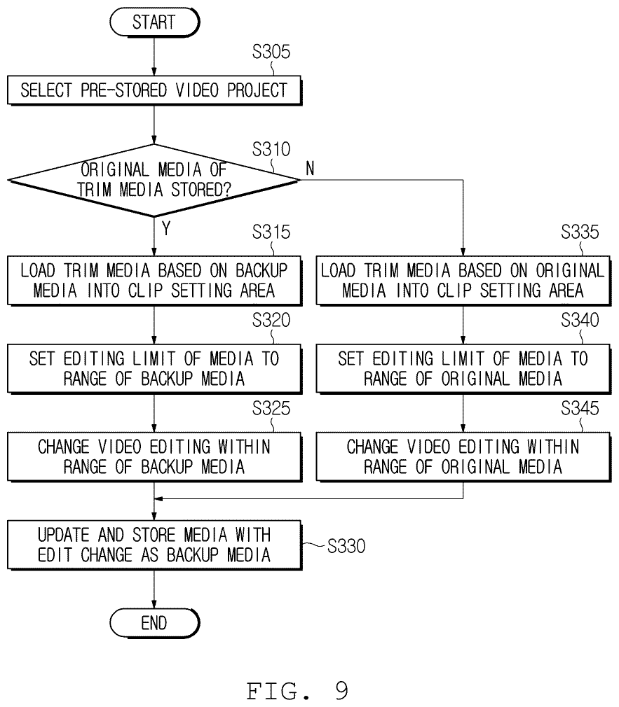

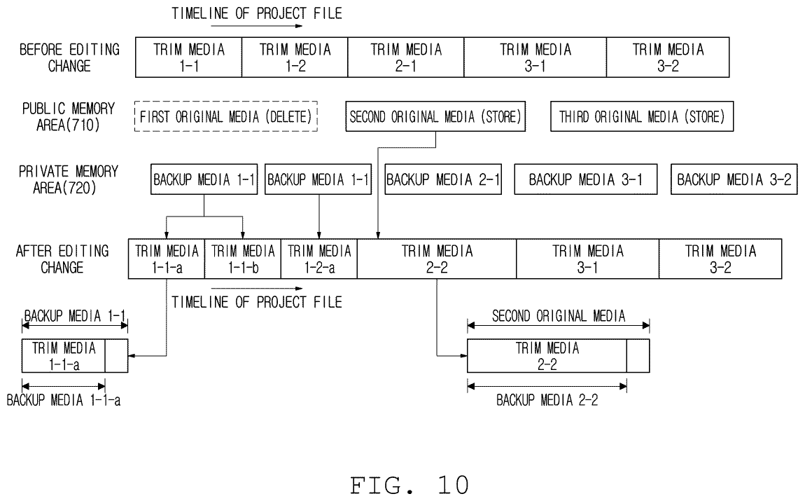

FIG. 9 is a flowchart of a video editing method capable of performing backup according to another embodiment of the present disclosure. FIG. 10 is a diagram illustrating an example of backing up trim media by performing the video editing method according to FIG. 9. For example, the process of FIG. 9 mayproceed as a detailed process of steps S125 and S130 of FIG. 3. In the present disclosure, it is assumed that the trim media is edited with only a portion of the original media and the trim media is mainly main trim media.

First, the processor 120 may receive a user's request through the editing application and call a pre-stored video project selected according to the request (S305).

Next, the processor 120 may check whether all of the original media is stored in the public memory area 710 for each trim media (S310).

If all of the original media related to at least one of the trim media is not stored in the public memory area 710, and only the backup media for the trim media is stored only in the private memory area 720 (N in S310), the processor (120) may load the trim media based on the backup media into the clip setting area, for example, the clip display window 404 (S315).

When trim media is loaded, the processor 120 may provide edited content in which the main and sub media are synthesized, and the main and sub clip lines 404a and 404b, through the video display window 401 and the clip display window 404. In addition, the processor 120 may provide various editing UIs capable of re-editing edited content.

Meanwhile, taking the main trim media as an example, only the main trim media 602a to 602c stored as the backup media may be loaded as main clips into the main clip line 404a shown in FIGS. 4 and 7A. The processor 120 may perform control to inquire only the main trim media corresponding to the range of the backup media of the related original media through the main clip line 404a and/or the video display window 401. This is because the original media including all the range excluded from the main trim media is deleted from the public memory area 710.

A detailed description will be given with reference to FIG. 10. If the first original media according to the trim media 1-1 and 1-2 according to previous editing is deleted from the public memory area 710, only the backup media 1-1 and 1-2 corresponding to the range of the trim media 1-1 and 1-2 of the first original media may be stored and managed in the private memory area 720. Here, the range may be a trim range of the first original media original media according to at least one of a time interval or a spatial area.

The processor 120 may load only main clips corresponding to the range of the backup media 1-1 and 1-2 related to the trim media 1-1 and 1-2, for example, into the main clip line 404a. Even if the user expands the window of the main clips loaded into the backup media 1-1 and 1-2 to the maximum, the user cannot check other parts of the first original media that are not included in the trim media 1-1 and 1-2).

Subsequently, the processor 120 may set the editing limit of the trim media loaded as the backup media to a backup media range (S320).

As an example, referring to FIG. 10, the processor 120 may also set the editing limits of the trim media 1-1 and 1-2 loaded in the main clip line 404a to the range of the backup media 1-1 and 1-2 according to the confirmation range determined in step S315.

Subsequently, the processor 120 may receive a request to change media editing by the user and change the editing of the trim media within the range of the backup media (S325).

As an example, referring to FIG. 10, the user may not edit the trim media 1-1 and 1-2 to add other parts of the first original media that are not included in the trim media 1-1 and 1-2, and may perform editing such as deletion and splitting within the trim media 1-1 and 1-2. As illustrated in FIG. 10, the user requests editing change based on the backup media 1-1 and 1-2, and the processor 120 may create trim media 1-1-a, 1-1-b and 1-2-a derived from the backup media 1-1 and 1-2.

Next, the electronic device may update and store the trim media, the editing of which has changed, as backup media (S330).

Taking the trim media 1-1-a, editing of which has changed in FIG. 10, as an example, the processor 120 may newly store, in the private memory area 720, the backup media 1-1-a corresponding to the edited trim media 1-1-a in the range of the previous backup media 1-1. The detailed method of storage is substantially the same as described in FIG. 6. For example, the backup media 1-1 may be moved to the public memory area 710 and managed as secondary original media according to a user's request or application settings. The secondary original media may be provided prior to the backup media 1-1-a in subsequent editing changes to the trim media 1-1-a. In this case, the editing limit of the trim media 1-1-a may be set to the range of the secondary original media. As another example, the backup media 1-1 maycontinue to be managed in the private memory area 720 and be provided as secondary original media in subsequent editing changes. In another example, the backup media 1-1 is deleted, so that the trim media 1-1-a based on the backup media 1-1-a may be loaded in subsequent edit changes, and the edit limits may also be set to the range of the backup media 1-1-a.

Meanwhile, if all of the original media related to at least one of the trim media and the backup media are stored in the public memory area 710 and the private memory area 720 (N in S310), the processor 120 may load the trim media based on the original media into the clip setting area, such as the clip display window 404 (S335).

The processor 120 may load main clips having second and third original media including all parts including the trim media 2-1, 3-1 and 3-2, prior to the backup media 2-1, 3-1 and 3-2 corresponding to the trim media 2-1, 3-1 and 3-2, in the main clip line 404a. Accordingly, the user may expand the window of the main clips to check other parts of the second and third original media that are not included in the primarily edited trim media 2-1, 3-1 and 3-2.

Subsequently, the processor 120 may set the editable limit of the trim media to the range of the original media (S340).

As an example, referring to FIG. 10, the processor 120 may also expand and set the editing limits of the trim media 2-1, 3-1 and 3-2 loaded in the main clip line 404a to the ranges of the second and third original media, according to the confirmation range determined in step S335.

Subsequently, the processor 120 may receive a request to change media editing by the user and change trim media editing within the range of the original media (S345).

As an example, referring to FIG. 10, the user may edit the trim media 2-1, 3-1 and 3-2 to add other parts of the second and third original media that are not included in the trim media 2-1, 3-1 and 3-2, and perform editing such as deletion and splitting within the trim media 2-1, 3-1 and 3-2. As illustrated in FIG. 10, the user requests an editing change based on the second and third original media, and processor 120 may create the trim media 1-1-a, 1-1-b and 1-2-a derived from the second and third original media.

Next, the processor 120 may update and store the trim media, the editing of which has changed by the user's request as backup media (S330).

Taking the trim media 2-2, the editing of which has changed in FIG. 10, as an example, the processor 120 may newly store the backup media 2-2 corresponding to the trim media 2-2 in the private memory area 720. The detailed method of storage is substantially the same as described in FIG. 6. The previous backup media 2-1 does not match the trim media 2-2, the editing of which has changed, and thus may be deleted from the private memory area 720. The second original media may not be deleted and, unless deleted, may be provided prior to the backup media 2-2 in subsequent editing changes of the trim media 2-2. In this case, the editing limit of the trim media 2-2 maybe set to the range of the second original media.

According to the present disclosure, even if the original media used in the edited video is deleted, the backup media may be stored and used in subsequent editing. In addition, by storing only at least a part of the original media used in the edited video as backup media, the memory capacity required for backup can be reduced.

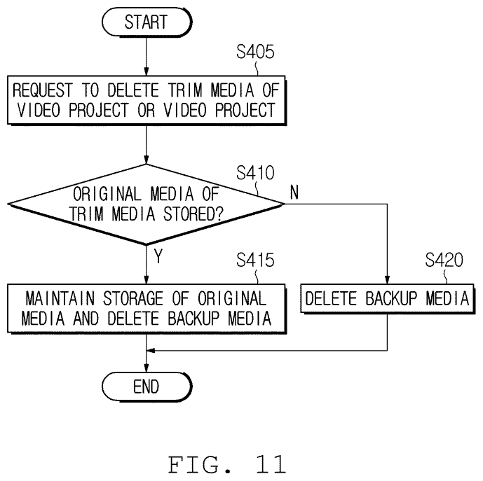

FIG. 11 is a flowchart illustrating a process of deleting backup media.

After the backup media is stored, the processor 120 may receive a request to delete the video project (S405).

In the request to delete the video project, if the original media of the trim media is stored in the public memory area 710 (Y in S410), the processor 120 may delete all trim media of the video project and all backup media corresponding thereto, but maintain storage of the original media related to the trim media (S415).

In contrast, if the original media of the trim media is not stored in the public memory area 710 (N in S410), the processor 120 may delete all trim media of the video project, as well as all backup media corresponding thereto (S420).

In the present and other embodiments, the processor 120 may receive the request to delete the trim media. In this case, the processor 120 may delete the backup media corresponding to the trim media together.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present invention by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

1. A video editing method capable of performing backup, comprising:
loading original media selected as an editing target by a user into a clip setting area of a video project;
creating trim media according to a trim request of the user for the original media loaded into the clip setting area; and
storing the trim media as backup media, in response to a request to set storage of the backup media in the video project by the user.

2. The video editing method of claim 1, wherein the storing as the backup media comprises storing a part of the original media corresponding to the created trim media as the backup media, in response to creation of the trim media using only at least a part of the original media by the trim request.

3. The video editing method of claim 2,
wherein the original media comprises at least one of a still image, a video or an audio,
wherein when the original media is a still image, the trim media is set to a trim area of the still image spatially designated by the user in the original media, and
wherein when the original media is a video, the trim media is set to a trim area of the video designated by the user for at least one of a time interval or a space in the original media.

4. The video editing method of claim 2,
wherein at least a part of the original media comprises all of the original media, and
wherein the storing as the backup media comprises storing all of the original media as the backup media, in response to reception of a user's trim request indicating that all of the original media is created as the trim media.

5. The video editing method of claim 1, wherein the original media is stored in a deletable memory area, and the backup media is stored in a memory area different from the deletable memory area not to be deleted without additional manipulation of the user.

6. The video editing method of claim 1,
wherein the generating the trim media comprises creating additional content by performing editing to add content to the trim media by the request of the user, and
wherein the storing as the backup media comprises storing trim media excluding the content as the backup media.

7. The video editing method of claim 1, further comprising:
after the storing as the backup media,
after the storing as the backup media,calling the video project including the trim media by the user;
loading the trim media based on the backup media into the clip setting area when original media of the trim media is not stored; and
setting an editable limit of media to a range of the backup media.

8. The video editing method of claim 7, further comprising:
loading the trim media based on the original media into the clip setting area when original media of the trim media is stored; and
setting an editable limit of the media to a range of the original media.

9. The video editing method of claim 7, further comprising:
receiving a user's request to change media editing to change media editing; and
updating and storing the media, the editing of which has changed, as the backup media.

10. The video editing method of claim 1, further comprising:
after storing as the backup media,
receiving a request to delete the video project or the trim media; and
deleting all of backup media corresponding to all trim media of the video project in response to the request to delete the video project or deleting backup media corresponding to the trim media in response to the request to delete the trim media.

11. A video editing device comprising:
a memory configured to store at least one instruction;
a display configured to display media; and
a processor configured to execute the at least one instruction stored in the memory,
wherein the processor is configured to:
load original media selected as an editing target by a user into a clip setting area of a video project;
create trim media according to a trim request of the user for the original media loaded into the clip setting area; and
store the trim media as backup media, in response to a request to set storage of the backup media in the video project by the user.

12. The video editing device of claim 11, wherein the storing as the backup media comprises storing a part of the original media corresponding to the created trim media as the backup media, in response to creation of the trim media using only at least a part of the original media by the trim request.

13. The video editing device of claim 12,
wherein the original media comprises at least one of a still image, a video or an audio,
wherein when the original media is a still image, the trim media is set to a trim area of the still image spatially designated by the user in the original media, and
wherein when the original media is a video, the trim media is set to a trim area of the video designated by the user for at least one of a time interval or a space in the original media.

14. The video editing device of claim 11, wherein the original media is stored in a deletable memory area, and the backup media is stored in a memory area different from the deletable memory area not to be deleted without additional manipulation of the user.

15. The video editing device of claim 11,
wherein the generating the trim media comprises creating additional content by performing editing to add content to the trim media by the request of the user, and
wherein the storing as the backup media comprises storing trim media excluding the content as the backup media.

16. The video editing device of claim 11, wherein after the storing as the backup media,
the video project including the trim media is called by the user,
the trim media based on the backup media is loaded into the clip setting area when original media of the trim media is not stored, and
an editable limit of media is set to a range of the backup media.

17. The video editing device of claim 16,
wherein the trim media based on the original media is loaded into the clip setting area when original media of the trim media is stored, and
wherein an editable limit of the media is set to a range of the original media.

18. The video editing device of claim 16,
wherein a user's request to change media editing is received to change media editing, and
wherein the media, the editing of which has changed, is updated and stored as the backup media.

19. The video editing device of claim 11, wherein after storing as the backup media, a request to delete the video project or the trim media is received, and all of backup media corresponding to all trim media of the video project is deleted in response to the request to delete the video project or backup media corresponding to the trim media is deleted in response to the request to delete the trim media.

20. A computer program stored in a recording medium readable by a computing electronic device in order to perform video editing method capable of performing backup, the method comprising:
loading original media selected as an editing target by a user into a clip setting area of a video project;
creating trim media according to a trim request of the user for the original media loaded into the clip setting area; and
storing the trim media as backup media, in response to a request to set storage of the backup media in the video project by the user.
